(19) United States
(12) Patent Application Publication
(10) Pub. No.: US 2022/0211565 A1
(43) Pub. Date: Jul. 7, 2022

(54) TREATMENT TABLE

(71) Applicant: Yasuhiko ISHIKAWA, Takamatsu-shi, Kagawa (JP)

(72) Inventor: Yasuhiko ISHIKAWA, Takamatsu-shi, Kagawa (JP)

(21) Appl. No.: 17/604,401

(22) PCT Filed: Feb. 17, 2020
(86) PCT No.: PCT/JP2020/006027

§ 371 Date: Oct. 16, 2021

(30) Foreign Application Priority Data
May 15, 2019 (JP) 2019-091800

(51) Int. Cl. A61G 13/08; A61G 13/12

(52) U.S. Cl. CPC A61G 13/08; A61G 13/1225; A61G 13/122

(57) ABSTRACT

A treatment table (1) includes a chest support part (3) and a leg support part (4) that respectively support a chest and legs of a patient while the patient lies on the treatment table, and a lower-back support part (20) that support a lower-back of the patient, and is located between the chest support part and the leg support part, wherein the lower back support part is provided with multiple divided members (21) that are divided in patient's body-axis and body-width directions, and supporting bodies that support the divided members (21) movably in an up-down direction. The treatment table offers to perform an effective lower-back treatment with an inexpensive configuration.

### TECHNICAL FIELD

This invention relates to a treatment table, and to be more detailed, it relates to a treatment table used preferably for the manual therapy of a patient's lower back.

### BACKGROUND

Known as a conventional treatment table used for the chiropractic therapy is a Thompson table disclosed in Patent Document 1 (e.g., Patent Document 1). The Thompson table has divided parts corresponding to the face, chest, lower back, and legs of a patient lying down, where the parts corresponding to the chest, lower back, etc. are made as drop parts that can individually move up or down. By this configuration, a treatment can be performed by lifting up any of the drop parts and instantaneously pressing the patient's treated part, thereby dropping the drop part.

### PRIOR ART

[Patent Doc. 1] U.S. Pat. No. 2,926,660

### SUMMARY

### Subject(s) of the Invention

Considered as the main cause of lumbago is a shift of the pair of sacroiliac joints that supports the left and right sides of the pelvis. The weight center of human body resides inside the pelvis, and if a shift occurs to the pair of sacroiliac joints, the weight center line of human body deviates from the proper central axis, thereby a distortion can occur to the whole body. Therefore, it is effective to correct the shift of the sacroiliac joints in treating lumbago.

However, in the conventional treatment table mentioned above, because the part supporting the patient's lower back drops integrally, the pair of sacroiliac joints drops simultaneously including their periphery, making a sufficient correction difficult.

Then, the objective of this invention is to offer a treatment table that allows performing an effective lower back treatment with an inexpensive configuration.

### Means to Solve the Subject(s)

The subject is achieved with a treatment table comprising a chest support part and a leg support part that respectively support a chest and legs of a patient while the patient lies on the treatment table, and a lower-back support part that support a lower-back of the patient, and is located between the chest support part and the leg support part, wherein the lower back support part is provided with multiple divided members that are divided in patient's body-axis and body-width directions, and supporting bodies that support the divided members movably in an up-down direction.

In the treatment table, each of the supporting bodies may be provided with a lifting means that raises one of the divided members, and a holding means that holds the raised divided member at a prescribed drop height, the holding means is further provided with an engaging piece that engages with the divided member by a bias force of an elastic member, and when an impact force is applied from above to the raised divided member held by the holding means, the engaging piece and the divided member disengage, thereby the divided member drops. It is preferred that the holding means is configured to be able to select the drop height of the divided member from multiple choices.

### Advantage(s) of the Invention

This invention can offer a treatment table that allows performing an effective lower-back treatment with an inexpensive configuration.

### BRIEF DESCRIPTIONS OF THE DRAWINGS

FIG. 1 is a plan view of a treatment table of an embodiment of this invention.

FIG. 2 is a cross-sectional view along A-A in FIG. 1.

FIG. 3 is an enlarged cross-sectional view of the main part of FIG. 2.

FIGS. 4A and 4B are enlarged cross-sectional views of the main part for explaining the operation of the treatment table of an embodiment of this invention.

### EMBODIMENT(S) OF THE INVENTION

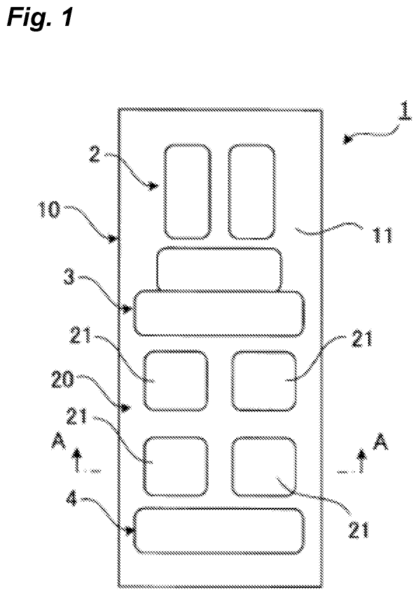

Below, an embodiment of this invention is explained referring to attached drawings. FIG. 1 is a plan view of a treatment table of the embodiment of this invention. As shown in FIG. 1, the treatment table 1 is provided with a head support part 2, a chest support part 3, a lower-back support part 20, and a leg support part 4 that respectively support the head, chest, lower back, and legs of a patient lying down above a top plate 11 of a table main body 10 formed in a chassis shape. The head support part 2, the chest support part 3, the lower-back support part 20, and the leg support part 4 should preferably be coated with a cushion material (not shown) or the like.

The lower-back support part 20 is provided with four divided members 21 that have a rectangular shape in a plan view and are arranged in a matrix shape divided in the body-axis direction (up-down direction in a standing state) and the body-width direction (right-left direction in a standing state) of the patient. The number of the divided members 21 is not particularly limited as far as they are divided in both the body-axis and body-width directions. The divided members 21 only need to be arranged so that the patient's lower back can be supported by them together, and they can be arranged in another shape such as zigzag than a matrix shape.

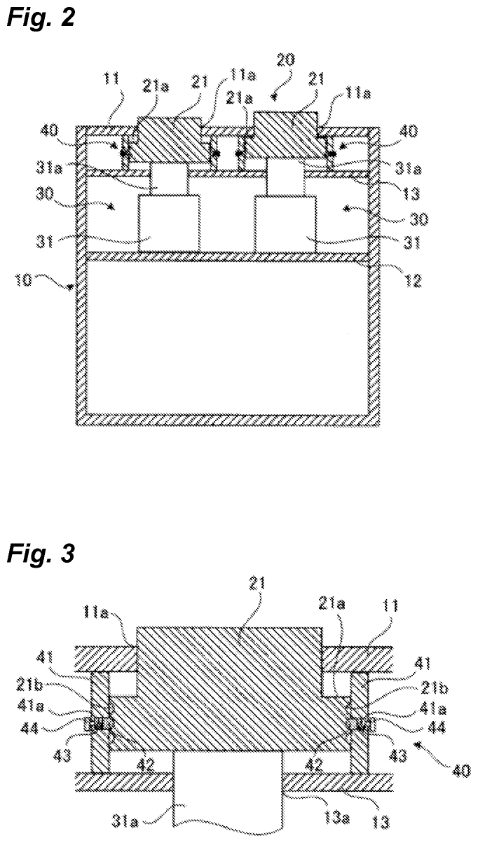

FIG. 2 is a cross-sectional view along A-A in FIG. 1. As shown in FIG. 2, the multiple divided members 21 are supported by supporting bodies 30 so that their top parts protrude through penetration holes 11a formed on the top plate 11. The supporting bodies 30 are provided with multiple lifting devices 31 that support the multiple divided members 21 so as to move individually up or down, and holding mechanisms 40 that hold the divided members 21 having risen by the lifting devices 31 at their respectively prescribed heights. The lifting devices 31 and the holding mechanisms 40 are respectively supported by two base plates 12 and 13 placed horizontally inside the table main body 10.

The lifting devices 31 are configured of fluid pressure cylinders such as air cylinders, where the upper ends of rods 31a detachably contact the lower faces of the divided members 21. The lifting devices 31 can be other devices such as jacks or chain blocks that can lift up the divided members 21, and the drive system can be automatized by utilizing a hydraulic or electrically-powered system other than a manual system. Formed on the divided members 21 are step parts 21a that contact the periphery of the penetration holes 11a of the top plate 11, thereby regulating any excessive rise of the divided members 21 by the operation of the lifting devices 31.

FIG. 3 is an enlarged cross-sectional view of one of the divided members 21 shown in FIG. 2. As shown in FIG. 3, the holding mechanisms 40 are provided with standing walls 41 that stand from the base plate 13 so that the rim parts of the supporting bodies 30 slide, and engaging pieces 42 accommodated in accommodating parts 41a formed on the standing walls 41.

The engaging pieces 42 each have a cross-sectionally arc-shaped tip part arranged so as to protrude horizontally by a bias force of an elastic member 43 made of a spring or the like, and can hold each of the divided members 21 by engaging with cross-sectionally arc-shaped engaging recesses 21b formed on side walls of the divided members 21. The pressing force of the engaging pieces 42 to the divided members 21 can be adjusted as appropriate by the advancement or retreat of adjusting screws 44. The specific configuration for the engaging pieces 42 to engage with the divided members 21 by the bias force of the elastic members 43 is not particularly limited, but for example, commercially-available index plungers can be used.

Although the engaging pieces 42 are installed corresponding to the rectangular sides of the divided members 21 in this embodiment, their arrangement only needs to allow holding the divided members 21, and for example, at least one engaging piece 42 can be arranged so as to engage with the mutually-opposing rims of each of the divided members 21.

The multiple engaging recesses 21b of the divided members 21 are formed along the height direction to allow holding the divided members 21 while changing their heights by selecting the engaging recesses 21b with which the engaging pieces 42 engage. The engaging pieces 42 do not necessarily need to engage with the engaging recesses 21b, but for example, can engage with the bottom face or protrusions of the divided members 21 as a configuration.

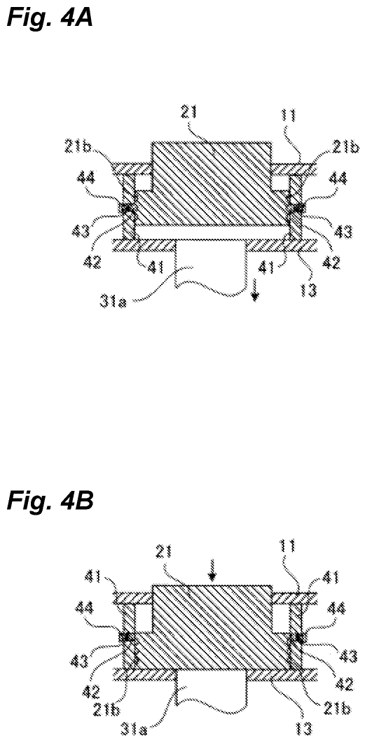

By the treatment table 1 provided with the above configuration, while a patient is lying down, from a state where one of the divided members 21 is lifted from below by the rod 31a of its lifting device as shown in FIG. 3, by lowering the rod 31a as shown in FIG. 4A, the engaging pieces 42 can engage with any set of the engaging recesses 21b, thereby holding the divided member 21 at a prescribed height. Afterwards, once a downward impact force acts on the divided member 21 by instantaneously pressing the patient's lower back, as shown in FIG. 4B, the engaging pieces 42 move against the bias force of the elastic members 43, thereby the engaging pieces 42 and the divided member 21 disengage, and the divided member 21 drops onto the base plate 13. In this manner, a force according to the force pressing the patient and the drop height of the divided member 21 can be applied to the patient's lower back.

In the treatment table 1 of this embodiment, the lower-back support part 20 that is arranged between the chest support part 3 and the leg support part 4 and supports the patient's lower back is provided with divided members 21 divided in the patient's body-axis and body-width directions, and the divided parts 21 are supported so as to move individually up or down, thereby an impact force acting on the patient's lower back does not act two-dimensionally in the up-down direction (body-thickness direction) in the individual positions along the body-axis direction as in the past, but acts three-dimensionally by adding the body-width direction to this. Therefore, by appropriately selecting the divided member 21 to be dropped in both the body-axis and body-width directions, the variation of the treatment can be enhanced, and a shift of the left and right of sacroiliac joints etc. can be effectively corrected.

Also, as in this embodiment, by adopting the configuration that allows selecting the drop heights of the individual divided members 21 by forming multiple engaging recesses 21b with which the engaging pieces 42 engage along the height direction, impact forces accompanying the drops of the individual divided members 21 can be individually set, facilitating a desired treatment. The drop height of any of the divided members 21 can be set by holding the rod 31a shown in FIG. 4A in a state protruding upward of the base plate 13 and adjusting the protrusion height of this rod 31a, or this can be combined with the selection of the multiple engaging recesses 21b. The drop heights of the divided members 21 are not particularly restricted but can be set within a range of about 1030 mm, and if the drop heights are set to two stages for example, it should preferably be configured so as to allow selecting either 15 mm or 30 mm.

As to the head support part 2, the chest support part 3, and the leg support part 4, in the same manner as in the lower-back support part 20, they can also be given a configuration provided with multiple divided members that are divided in the patient's body-axis and body-width directions and can individually move up or down.

### LEGEND

1: Treatment table
3: Chest support part
4: Leg support part
20: Lower-back support part
21: Divided members
30: Supporting bodies
31: Lifting devices
40: Holding mechanisms
42: Engaging pieces
43: Elastic members

What is claimed is:

1. A treatment table comprising:
a chest support part and a leg support part that respectively support a chest and legs of a patient while the patient lies on the treatment table, and
a lower-back support part that support a lower-back of the patient while the patient lies on the treatment table, and is located between the chest support part and the leg support part, wherein
the lower back support part is provided with
multiple divided members that are divided in patient's body-axis and body-width directions, and
supporting bodies that support the divided members movably in an up-down direction.

2. The treatment table according to claim 1, wherein
each of the supporting bodies is provided with a lifting means that raises one of the divided members, and
a holding means that holds the raised divided member at a prescribed drop height,
the holding means is further provided with an engaging piece that engages with the divided member by a bias force of an elastic member, and
when an impact force is applied from above to the raised divided member held by the holding means, the engaging piece and the divided member disengage, thereby the divided member drops.

3. The treatment table according to claim 2, wherein
the holding means is configured to be able to select the drop height of the divided member from multiple choices.
